(19) United States
(12) Patent Application Publication
(10) Pub. No.: US 2010/0122316 A1
(43) Pub. Date: May 13, 2010

(54) User Controlled Identity Authentication

(76) Inventor: Dennis Bower Lyon, (US)

Correspondence Address: Dennis Bower Lyon, 905 Tempera Court, Oceanside, CA, 92057-7910, US

(21) Appl. No.: 12/269,672

(22) Filed: Nov. 12, 2008

(51) Int. Cl. G06F 21/00

(52) U.S. Cl. 726/1

(57) ABSTRACT

A system, method for user controlled identity authentication comprising: a) At least one central computer having at least one user within a user database having user data and at least one service provider within a service provider database with service provider data; b) At least one service provider having electronic communication with the central computer; c) At least one user having electronic devices capable of communications with the central computer and service provider; e) Providing a user with a set of controls within the central computer to customize privacy, security and authentication of the user data; f) Providing a set of access rights within the service provider data of the central computer having a set of transaction rules for the service provider.

### BACKGROUND

Identity theft is the fastest growing crime in the United States and in the world costing banks billions of dollars yearly. The current disparate systems in place to authenticate and verify a person's identity are no longer sufficient as well as efficient. Terrorists have exploited the holes within the identity systems currently in place as seen on Sep. 11, 2001.

### SUMMARY OF THE INVENTION

The present system generally relates to identity authentication, and in particular, a system and method of user controlled authentication and consent of personal data within a plurality of computer systems for both logical and physical access.

A system, method for user controlled identity authentication comprising: a) At least one central computer having at least one user within a user database having user data and at least one service provider within a service provider database with service provider data; b) At least one service provider having electronic communication with the central computer; c) At least one user having electronic devices capable of communications with the central computer and service provider; e) Providing a user with a set of controls within the central computer to customize privacy, security and authentication of the user data; f) Providing a set of access rights within the service provider data of the central computer having a set of transaction rules for the service provider;

In order for a user and a service provider to use the system, the user must first enroll into the identity system. Enrollment is done by a service provider with access rights to add a new user to the identity system. Access rights are a set of restrictions to service providers that enable them to conduct certain transactions on the identity server. Access rights are dependent on the type of service provider, for example the social security administration may have the access rights within the identity system to add a new user, creating a new user profile; a financial institution may have the right to add and/or remove bank account information such as accounts, debit cards and/or credit cards; The DMV may have the right to add or remove a drivers license to a user's identity profile; The US Post Office may have rights to add or remove a passport; The FBI or CIA may have the right to add secret access or levels of access for secure access to online portals, documents and or buildings herein called user access rights. The enrollment via a service provider may include a user that is already a user within the identity system. When a user is present to enroll and verify identity documents of a new user the enrolling user is scored within the user profile within the identity server. Users are scored when they transact with one another within the identity system. For example if a user were to allow a user with fraudulent identity proving documentation and it is later found that the user was fraudulent a negative impact would be recorded against the score of that person who enrolled that user. This may later affect how a service provider looks upon that user for a job opportunity trust or even obtaining user access rights. Once a user is enrolled the method of enrollment is identified as a high verification enrollment or an enrollment in person. The user may also enroll directly to the identity server whereby the user inputs identity data without a service provider or another user interaction. This enrollment difference is recorded as a low identity verification enrollment. The two differences allow service providers to allow or restrict a user from access based on the enrollment type. Another feature is that a high verification enrollment with a service provider may override and/or overwrite an existing user's profile if the enrollment was done directly or the low verification method. At this point the service provider or identity system may issue a token or multiple tokens to access the identity system.

A user may now manage the user profile or new identity created within the identity system. In a preferred embodiment of the current invention it would be preferred that a user have at least one level of security higher to logon onto their identity profile than would be required by a service provider. This can be accomplished by a factor of authentication or a combination or a multiple of one factor of security. The three factors of security include what you know (passwords, secrets), what you have (ID cards, tokens, computers, cell phone, etc) and what you are (body measurements, DNA, etc). For example a user may have two tokens one of which is required to logon to their identity profile within the identity system. Once a user is logged on, a user is presented with a multitude of options for privacy and security. These settings include user consent for personal data passing to a service provider. A user may restrict and/or allow as much or as less personal data to a service provider who may query for the information. However a service provider may deny registration to their system if the user restricts too much personal data. The user is also enabled to add/or remove other tokens, devices and biometrics to their identity profile for use in authentication. The user may add these forms of authentication based on time, for example a user may wish to add a computer for authentication but the user's computer is 10 miles away. The user may open a time window of an hour giving the user an hour to log onto the new device the user wishes to add. The user may have multiple device therefore would open multiple time sessions and/or select an amount of devices from within the user's profile. The user may also distinguish devices and/or tokens by administrator or guest. For example the user may restrict certain transaction from this difference. A service provider may use the difference as a form of authentication, for example high dollar value transactions must be done from administrator devices. A user may also wish to set their security settings above what a service provider may require enabling the user to add a plurality of authentication enabling the user to protect his or hers identity. For example, a service provider only requires password security to access an online resource; the user may set biometrics, tokens, devices or any number of authentication that the user wishes to logon onto the service provider resource. Although adding more authentication may not be convenient, it may be convenient to the user, hence the word user controlled authentication.

Once a user is enrolled and has set their privacy and security settings, the user may register and authenticate with a plurality of service providers that rely on the identity system. The user instead of typing in personal information into web forms would simply authenticate with the service provider. The service provider would send the authentication to the identity system for authentication along with a query of data the service provider wishes to populate within the service provider's system. If the response from the identity server is satisfactory, the user is granted access to the service provider's resources; Depending on the type of service provider and the rights granted by the identity system, the service provider may add or remove data from the user's identity profile.

The identity system allows service providers a unique way of physical and logical access. For example; if Betty were in Florida and her daughter wishes access to Betty's home in California but her daughter does not have access; Her daughter may authenticate against a locking device that is communicating with the service provider which in turn is sending the authentication to the identity system for verification. The service provider sends a message on Betty's device confirming identity, but maybe Betty wishes her daughter to prove identity even more with a biometric or token. The instructions are sent back to the service provider and then sent to the locking device. Betty's daughter reads the instructions and complies. The authentication is verified and sent to Betty and is given the option to unlock her door. From Florida Betty was able to give access to her home. Betty can give access to anyone or even add users to a white list via a social security number or serial number. The identity system can be used to register and vote from a home computer since the authentication is such to a degree that it eliminates identity fraud. The identity system allows for one access card or token to carry all a person would need to conduct financial transactions, access to secure areas, carry levels of authority, passports, driver's license and much more. Another configuration for a service provider would be that of car doors and starters. For example; John receives his driver's license and this license is added to his identity profile on the identity system. A service provider with a locking mechanism and the starter authenticates validity of the user's license upon opening the car doors and especially starting the vehicle. John later has his license revoked by the DMV and it is subsequently red flagged or removed on John's identity profile. John attempts to unlock the vehicle and depending on how the service providers set rules may be allowed to enter the vehicle. But John wants to drive away but John cannot start the vehicle because his identity profile says his driver's license has been revoked or red flagged. Service providers range from small free services such as free email providers to us defense systems especially in the realm of releasing weapons of mass destruction. A free email service provider using the identity system can be assured that a user has only registered once instead of a user registering for a plurality of accounts and beginning a spam campaign.

### BRIEF DESCRIPTION OF THE DRAWING

FIG. 1, Identity System, Method Schema

### DETAILED DESCRIPTION OF DRAWING

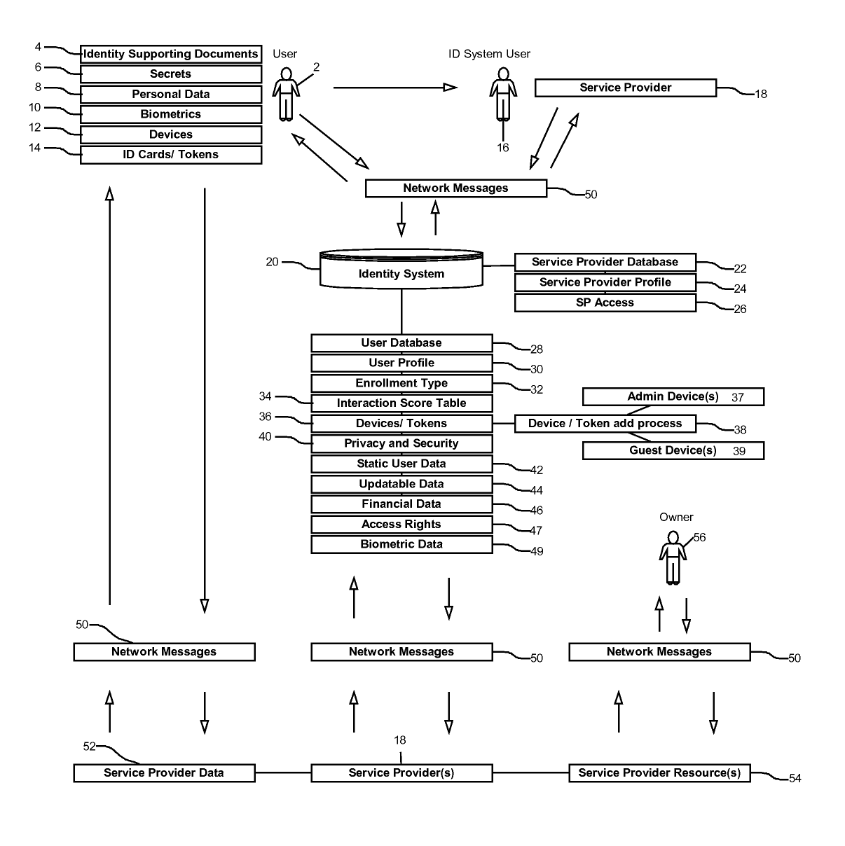

FIG. 1,

User 2: person.

Identity Supporting Documents 4: documents supporting identity such as a birth certificate. Secrets 6: passwords and/or personal secret information.

Personal Data 8: including social security number, serial number, date of birth, address, phone number, email address, photographs or any other data of personal nature.

Biometrics 10: includes any measurable part of a person's body such as fingerprints, DNA, photographs, etc.

Devices: 12: includes any electronic device that can communicate over an electronic network including computers and cell phones.

ID Cards/Tokens 14: similar to devices having the ability to communicate to other devices of the user and/or service provider, including smart cards, tokens devices, etc.

ID System User 16: is a user that is already enrolled within the identity system 20.

Service Provider 18: includes computer systems having communications with the identity system, this may be one computer system or many.

Network Messages 50: are electronic messages between electronic devices and/or computer systems.

Identity System 20: is the central computer system for identity authentication.

Service Provider Database 22: is the database within the identity system 20, containing a plurality of service provider profiles 24.

Service Provider Profile 24: is where the data for a service provider 18, is stored.

Service Provider Access Rights 26: is the data within the service provider profile 18, having the access rights of the service provider 18 to the identity system 20.

User Database 28: contains a plurality of user profiles 30, within the identity system 20.

User Profile 30: contains the elements of user controlled authentication and consent.

Enrollment Type 32:

Interaction Score Table 34: is a score given to a user for interaction with other users within the identity system 20. is a data table containing the method of which a user enrolled into the identity system 20.

Devices and Tokens 36: is a data table containing all the tokens, smart cards, computer devices used for authentication.

Device and Token add process 38: is a process of adding a device or token to the devices and tokens data table 36, wherein an open time session is created and number of devices is selected wherein a user has to add the device(s) within the time period open by the user.

Admin Device(s) 37: are devices and/or tokens selected by a user within the devices and tokens data table 36, with administrator rights and may be used as a selection within the authentication process to restrict access to certain transaction or access.

Guest Device(s) 39: are devices and/or tokens added to the devices and tokens table 36, with limited and/or guest access and may be used as a selection within the authentication process to restrict access to certain transaction or access.

Privacy and Security 40: are settings that a user may select to restrict, allow and/or consent to what personal data may pass to a service provider, furthermore a selection allowing a user to minimize or maximize authentication even beyond what a service provider may require.

Static User Data 42: is data that will not change during the lifetime of the user such as a serial number, social security number, date of birth or any other static data restricting a user from existing twice within the identity system 20.

Updatable Data 44: includes a user's address, phone number, email address and any other data that may change during the user's lifetime.

Financial Data 46: contains a user's financial information that may be added by a financial service provider 18, including accounts numbers, debit cards, credit cards and any other financial data that may be passed to a second service provider for financial transactions. Access Rights 47: is a data table containing data added by a service provider 18, having authoritative access rights 26, within the identity system 20, to add or remove data including drivers license, passports, secret access, federal access, local authority or any other access right that may added to enable secure access to physical or logical resources.

Biometric Data 49: is a data table containing measurements from a user to use as authentication via biometric devices. Certain data may be added by the user and certain data may be static if enrolled via a service provider 18.

Service Provider Data 52: is data within a service provider that may include their custom rules of authentication, databases, and legacy login systems.

Service Provider Resource 54: this may include locking devices, other service providers or any other resource that a service provider may have.

Owner 56: is the owner of the resource within the service provider and may be a user of the identity system 20.

The present invention aims to solve the mentioned problems with a general method. The method will be described with respect to one embodiment. One skilled in the art will recognize that a great many embodiments of the present invention exist.

Referring now to FIG. 1, details a preferred embodiment of a network schema for identity authentication for secured logical and physical access.

User 2, enrollment to the identity server 20, is accomplished through a service provider 18, that may have a user operator 16, or enrollment may be directly with the identity server 20, and is defined in the user database 28, within enrollment type 32. An enrollment that is conducted via a service provider 18, having a high verification may overwrite a user's profile that was conducted via directly to the identity server 20, wherein the user supplied the data to enroll. If a user is present 16, to enroll user 2, then an interaction score is generated for user 16, within score table 34, profile 30. This may be used in the case that a user operator allows a user 2, to enroll within the identity system 20, using fraudulent identity documents 4. Service providers 18, may consider the score 34, as a means of access or employment. Data supplied by the user that is static will become the unique identifier within the identity system 20, and stored within the user profile 42, allowing that user to exist only once within the identity system 20. The service provider 18, may have a service provider profile 24, within the service provider database 22, having a set of access rights 26, to transact with the identity server 20, via network messages 50. Upon enrollment the user 2, may receive a token 14, from the service provider 18, or directly from the identity server 20.

The user 2, may log into the identity system 20, with a device and/or token 14, and in a preferred embodiment have an extra layer of security higher than that of any service provider 18, may have. The user 2, may customize the privacy and security settings 40. The user may add devices and/or tokens wherein the user 2, would open a time session and may set the amount of devices to be added 38. The user 2, may also distinguish devices and token by administrator 37, and/or guest 39, to limit or restrict authentication with service providers 18. A static biometric 10 may be obtained from a user 2, wherein a service provider 18, that may have a user operator 16, and updated or uploaded to user 2, biometric data 49. The user 2, may also wish to add biometric data 10, to their own user profile 30. The user 2, may wish to set passwords, pin number and/or secrets 6, to authenticate and reset passwords.

User 2, may interact with a service provider 18, wherein the user 2, may register by simply authenticating to the service provider 18, wherein the service provider may pass the authentication via 50, along with a query of data requested by the service provider 18, to the identity system 20. Identity system 20, may respond based on the user's 2, privacy and security settings 40, the access rights of the service provider 26, the devices and tokens 36, and a plurality of factors based on the service provider 18, requirements and user 2, settings. The identity server 20, may send personal data from the user's 2, profile 30, based on the user's 2, consent. The service provider 18, may populate database 52, and give access to a resource 54.

A service provider 18, configuration of resources 54, may be a door locking device requiring secure access to an area or building. A user 2, may authenticate against the resource 54, wherein the authentication data may be sent to the service provider 18, and sent to the identity server 20, for authentication response 50. Upon response 50, the user 2, may be within the service provider 18, database 52, white list for access wherein the resource 54, may grant access. Alternatively, the owner 56, of the resource may receive network notice 50, of a person wishing access to the resource 54. The owner 56, may wish more authentication of the user 2, of any elements 6, 10, 12, or 14, within the user profile 30, of the identity server 20, before granting access. This is just one example of how a service provider 18, may be configured to use the identity server 20, for authentication.

The advantages of the present invention include, without limitation, are the controls in place, available for both users and service providers. The ability to control what data may pass to a service provider and the ability for service providers to decide on that data. A user may increase the authentication beyond what a service provider may require to prove identity. The identity system allows multi-factor authentication logically and physically with as many tokens and devices and/or passwords or consolidated within one device, token, card and/or password depending on the security threshold of a service provider. An example of use would be a user who is issued a drivers license by a service provider with authority to add the drivers license later revokes the license and subsequently the user attempts to unlock or start their vehicle with a network locking device may be denied access. Another use would be a passport issued within the identity system can be quickly tracked at points of entry and denied access instantly by revoking passport rights. Another use would be access to federal buildings, that may be restricted and certain locking devices or secure areas may be restricted if the correct access rights of the user does not exist within the user's profile. Online resources and/or documents may be restricted by access right. Another example would be that an owner of a home in California may be on vacation in Hawaii and a son or daughter may wish to access the home but does not have the keys. The identity system through a service provider with a locking device network may be configured to send a network message to the owner of the portable device designated and inform the owner that the son or daughter wishes access and is authenticated. The owner may wish to have the son prove identity further via biometrics or other authentication means before allowing the son or daughter to enter and sending a message back to the service provider lock network to unlock the device. A total compromise of a person's data becomes useless within the identity system since the data must be rendered by the identity server to the service providers. This model would definitely eliminate the threat of identity theft. The ability to score interaction within users within the system; For example a user working at a service provider capable of adding new users to the identity system would fraudulently create an identity for a friend within the identity system. It is later known that the new user added to the system is a fraud. The user who enrolled the user may be penalized through the score model which later may affect their access rights and or later job opportunities. The system may be a prelude to a one united global identification system and card meaning that you would only need one card to conduct every transaction in life.

While the foregoing written description of the invention enables one of ordinary skill to make and use what is considered presently to be the best mode thereof, those of ordinary skill will understand and appreciate the existence of variations, combinations, and equivalents of the specific embodiment, method, and examples herein. The invention should therefore not be limited by the above described embodiment, method, and examples, but by all embodiments and methods within the scope and spirit of the invention as claimed.

I claim:

1. A system, method for user controlled identity authentication comprising:
A) At least one central computer having at least one user within a user database having user data and at least one service provider within a service provider database with service provider data;
B) At least one service provider having electronic communication with the central computer;
C) At least one user having electronic devices capable of communications with the central computer and service provider;
D) Providing a user with a set of controls within the central computer to customize privacy, security and authentication of the user data;
E) Providing a set of access rights within the service provider data of the central computer having a set of transaction rules for the service provider;

2. The system, method as in claim 1, further comprising an data table within the user data of the central computer having the method of the user enrollment;

3. The system, method as in claim 2, wherein the service provider may restrict access to resources based on the user enrollment method;

4. The system, method as in claim 1, further comprising a second user having user data within the user database of the central computer;

5. The system, method as in claim 4, further comprising a data table within the user data of the central computer having a score based on the interaction of the first user with the second user;

6. The system, method as in claim 5, wherein a service provider may use the score of the user to determine access or issuance of data to the user data;

7. The system, method as in claim 1, further comprising a data table within the user data of the central computer having a difference of administrator and guest between devices and tokens;

8. The system, method as in claim 7, providing a method for adding devices and token based on time and amount of devices and tokens;

9. The system, method as in claim 7, providing a method for the service provider and the user to distinguish a difference between devices and token and enabling authentication based on the difference;

10. The system, method as in claim 1, further comprising a data table within the user data of the central computer wherein the service provider may add, remove and change data;

11. The system, method as in claim 10, wherein the service provider may be limited and restricted to add, remove and change the data table based on the access rights within the service provider data within the service provider database of the central computer;

12. The system, method as in claim 1, further comprising of a data table within user data within the central computer having data that may be changed and updated by the user;

13. The system, method as in claim 1, further comprising a data table within the user data of the central computer having static data of the user that does not change enabling the user to only exist once within the central computer;

14. The system, method as in claim 1, further comprising of a data table within the user data of the central computer having the user's biometric data;

15. The system, method as in claim 14, wherein the service provider may require authentication of this type from the user;

16. The system, method as in claim 1, providing the service provider with access to the user data within the central computer based on the user's privacy and security settings and the service provider access rights to the central computer;

17. A system, method for user controlled identity authentication comprising:
A) At least one central computer having at least one user within a user database having user data and at least one service provider within a service provider database with service provider data;
B) At least one service provider having electronic communication with the central computer;
C) At least one user having electronic devices capable of communications with the central computer and service provider;
D) Providing a user with a set of controls within the central computer to customize privacy, security and authentication of the user data;
E) Providing a set of access rights within the service provider data of the central computer having a set of transaction rules for the service provider;
F) At least one service provider with communications with a resource;

18. The system, method as in claim 17, further comprising a owner of the resource of the service provider;

19. The system, method as in claim 18, wherein the user may authenticate against the resource and the owner may respond to the service provider with instructions to the resource and the user;
